(19) United States
(12) Patent Application Publication
(10) Pub. No.: US 2026/0061905 A1
(43) Pub. Date: Mar. 5, 2026

(54) LOCKING MECHANISM FOR SEAT EXTENSION OF VEHICLE

(71) Applicants: Hyundai Motor Company, Seoul (KR); Kia Corporation, Seoul (KR); Yanfeng International Seating Systems Co., Ltd., Pudong New Area Shanghai (CN)

(72) Inventors: Shuo Hui Zhang, Yantai (CN); Xin Zheng, Yantai (CN); Ji Hyun Kim, Hwaseong (KR); Shuan Wang, Pudong New Area Shanghai (CN); Teng Gao, Pudong New Area Shanghai (CN); Can Zhang, Pudong New Area Shanghai (CN)

(21) Appl. No.: 19/306,542

(22) Filed: Aug. 21, 2025

(30) Foreign Application Priority Data
Aug. 28, 2024 (CN) 202411196960.X

(51) Int. Cl. B60N 2/36

(52) U.S. Cl. CPC B60N 2/366; B60N 2002/363

(57) ABSTRACT

A locking mechanism is arranged in a vehicle for detachably mounting a seat extension onto a seat backrest. The locking mechanism includes: an engagement plate mounted on the seat extension and having an opening in the engagement plate, a bracket mounted on the seat backrest, a housing mounted on the bracket and including a recess in the housing, a locking lever including a handle and a lever, the lever protruding from a bottom surface of the recess by passing through the opening in the engagement plate and the recess in the housing and having a pinhole disposed in an end portion of the lever, a pin shaft inserted into the pinhole in the end portion of the lever, and a spring disposed between an outer surface of the recess and the pin shaft.

### CROSS-REFERENCE TO RELATED APPLICATION

This application claims under 35 U.S.C. § 119(a) the benefit of Chinese Patent Application No. 200411196960.X filed with the Chinese Intellectual Property Office on Aug. 28, 2024, the entire contents of which are incorporated herein by reference.

### BACKGROUND

### (a) Technical Field

The present disclosure relates to a locking mechanism for a vehicle, more particularly, to the locking mechanism for a seat extension of a seat, such as a rear seat, of the vehicle.

### (b) Description of the Related Art

Recently, consumers have been increasingly demanding an extendable space of a vehicle rear seat, and the number of young people who enjoy driving and camping has been steadily increasing. These consumers desire that the vehicle rear seat may be completely folded and extended into a bed for rest. A luggage loading space may be utilized as a bedroom or a resting space where a passenger may lie down. This space is usually approximately 1.5 meters long, and may be excessively narrow for the passenger to lie down completely and stretch his/her legs.

Therefore, research has been conducted on a method for providing an extension space for the luggage loading space by utilizing a foldable backrest of a rear seat. However, when the backrest is folded forward to extend the luggage loading space, a floor surface of the extended luggage loading space does not match the existing floor surface of the luggage loading space. In addition, a backrest length of the rear seat is approximately 0.67 m. Accordingly, even though the luggage loading space is extended, the space may be unable to be fully extended because a pillow space or the like is required.

In addition, in most vehicles, even if the rear seat is completely folded and the seat may be horizontally disposed completely, a large gap may occur between the seat backrest and a luggage board, which may be inconvenient for the consumer to use. Such a gap may be eliminated by disposing a seat extension between the seat backrest and the luggage board. However, storing the seat extension may be difficult. Therefore, the gap between the seat backrest and the luggage board is required to be covered when the seat extension is unfolded, while ensuring that the seat and the luggage loading space remain unaffected when the seat extension is stored.

Therefore, there is a need for a seat extension for the vehicle that may be stored quickly without interfering with other components.

The above information disclosed in this Background section is provided only to assist in a better understanding of the background of the present disclosure, and may therefore include information that is not a part of the prior art already known to those skilled in the art to which the present disclosure pertains.

### SUMMARY

The present disclosure provides a locking mechanism for a seat extension for a vehicle, in order to quickly lock or unlock the seat extension. According to the present disclosure, a locking mechanism for a seat extension for detachably mounting the seat extension onto a seat backrest of a vehicle includes: an engagement plate mounted on the seat extension and having an opening disposed in the engagement plate; a bracket mounted on the seat backrest; a housing mounted on the bracket and including a recess disposed in the housing; a locking lever including a handle and a lever, the lever protruding from a bottom surface of the recess by passing through the opening in the engagement plate and the recess in the housing and having a pinhole disposed in an end portion of the lever; a pin shaft inserted into the pinhole in the end portion of the lever; and a spring disposed between an outer surface of the recess and the pin shaft.

In operation, when the seat extension is to be unfolded, the locking lever is turned and passes through the opening in the engagement plate to be stored in the recess in the housing, thereby allowing the seat extension to be unfolded beyond the locking lever.

When the seat extension is to be stored, the seat extension is folded onto the seat backrest, and the locking lever is pulled and turned, thereby allowing the handle of the locking lever to be engaged with an edge of the opening in the engagement plate.

According to an embodiment, a locking mechanism is provided for a seat extension for detachably mounting the seat extension onto a seat backrest. The locking mechanism includes: an engagement plate; a housing; a bracket; a locking lever; a spring; and a pin shaft, wherein the engagement plate is mounted on the seat extension and includes an opening disposed in the engagement plate, the bracket is mounted on the seat backrest, the housing is mounted on the bracket and includes a recess disposed in the housing, the locking lever includes a handle and a lever, the lever protruding from a bottom surface of the recess by passing through the opening in the engagement plate and the recess in the housing and having a pinhole disposed in an end portion of the lever, the pin shaft is inserted into the pinhole in the end portion of the lever, and the spring is disposed between an outer surface of the recess and the pin shaft, and wherein when the seat extension is to be unfolded, the locking lever is turned and passes through the opening in the engagement plate to be stored in the recess in the housing, thereby allowing the seat extension to be unfolded beyond the locking lever, and when the seat extension is to be stored, the seat extension is folded onto the seat backrest, and the locking lever is pulled and turned, thereby allowing the handle of the locking lever to be engaged with an edge of the opening in the engagement plate.

The opening in the engagement plate may be a cross-shaped hole, the cross-shaped hole including an opening in a first direction and an opening in a second direction, an opening length in the first direction being greater than or equal to a length of the handle, and an opening length in the second direction being less than the length of the handle, and the recess in the housing may be a cross-shaped recess, the cross-shaped recess including a recess in the first direction and a recess in the second direction, a recess length in the first direction being greater than or equal to the length of the handle, and a recess length in the second direction being less than the length of the handle.

The first direction may be a horizontal direction, and the second direction may be a vertical direction.

The buffer component may be disposed within the bottom surface of the recess, and a buffer column may be disposed on the handle and corresponds to the buffer component.

An engagement element may be disposed on one of the bracket and the housing, an engagement groove may be disposed in the other of the bracket and the housing, and the housing may be mounted on the bracket by coupling the engagement element to the engagement groove.

A circlip groove may be disposed in the pin shaft, and the circlip may be engaged with the circlip groove.

The circlip groove may be disposed in a middle portion of the pin shaft, a hole may be disposed in an end portion of the locking lever, an insertion groove may be disposed in the hole, and the circlip may be engaged with the circlip groove of the pin shaft along the insertion groove.

A guide block may be disposed on the end portion of the lever, the guide block is disposed on an inner side of the pin shaft, a guide hole may be disposed in the bottom surface of the recess, a guide surface may be disposed on an outer surface of the guide hole, and the guide block may be joined to the guide surface by a force of the spring.

The guide surface may include a first section, a transition section, a second section, and a stopper section, distances by which the first section, the second section, and the stopper section respectively protrude from the bottom surface of the recess may increase sequentially, and the transition section may be an inclined portion between the first section and the second section.

A joining block may be disposed on the lever and joined to the guide hole, and the joining block may be disposed at a position closer to the handle than the guide block of the lever.

The mechanism may further include a washer, wherein the washer may be disposed between the spring and the pin shaft.

A gripping portion may be disposed on a side of the handle, and a protrusion point may be disposed on the gripping portion.

A seat of a vehicle (e.g., a rear seat) may include the locking mechanism.

In particular, a vehicle may be equipped with the locking mechanism.

The locking mechanism for the seat extension according to an embodiment of the present disclosure provides the following advantages.

When the seat backrest is completely folded to form a bed together with a luggage board, the seat extension may be separated from the seat backrest and spread out between the seat backrest and the luggage board, thereby eliminating a gap between the seat backrest and the luggage board.

The locking mechanism does not protrude from a surface of the seat backrest after the seat extension is unfolded, and accordingly, there is no protrusion that may cause inconvenience to a user when the seat backrest is unfolded flat and the user lies down to rest. Furthermore, the locking mechanism has a simple structure, convenient manipulation, and low cost.

In addition, any advantage which may be acquired or inferred from an embodiment of the present disclosure is directly or implicitly disclosed in the detailed description of an embodiment of the present disclosure. That is, various advantages inferred from an embodiment of the present disclosure are disclosed in the detailed description described below.

### BRIEF DESCRIPTION OF THE DRAWINGS

Hereinafter, an embodiment of the present disclosure is described in more detail with reference to the accompanying drawings. For clarity of description, identical components in different drawings are indicated using the same reference numerals. It should be noted that the drawings are illustrative only and are not necessarily drawn to scale.

FIG. 1 is a schematic exploded view of a locking mechanism for a seat extension of a vehicle according to an embodiment of the present disclosure.

FIG. 2 is a cross-sectional view of a locking mechanism for a seat extension according to an embodiment of the present disclosure.

FIG. 3 is a schematic perspective view of a locking lever included in a locking mechanism for a seat extension according to an embodiment of the present disclosure.

FIG. 4 is a schematic view of a circlip included in a locking mechanism for a seat extension, which is disposed within a locking lever, according to an embodiment of the present disclosure.

FIG. 5 is a partial schematic view of a locking mechanism for a seat extension according to an embodiment of the present disclosure, as viewed from the rear.

FIG. 6 is a schematic cross-sectional view of a locking lever and a housing included in the locking mechanism for a seat extension according to an embodiment of the present disclosure.

FIG. 7 is a schematic view of a locking lever and a housing included in a locking mechanism for a seat extension according to an embodiment of the present disclosure, as viewed from the rear, where a pin shaft, a circlip, and other components are not shown.

FIG. 8 is a schematic view showing a guide block and a guide surface of a locking mechanism for a seat extension according to an embodiment of the present disclosure.

FIG. 9 is a schematic view of a handle position in a stored state of a seat extension.

FIG. 10 is a schematic view of a handle position in an unfolded state of a seat extension.

FIG. 11 is a schematic view of a modified example of a locking mechanism for a seat extension according to an embodiment of the present disclosure.

FIG. 12 is a schematic view of a seat extension in a stored state in a locking mechanism for a seat extension according to an embodiment of the present disclosure.

FIG. 13 is a schematic view of a seat extension in an unfolded state in a locking mechanism for a seat extension according to an embodiment of the present disclosure.

FIG. 14 is a schematic view of a seat extension in an unfolded state in a locking mechanism for a seat extension according to another embodiment of the present disclosure.

Unless otherwise described, the same reference numerals or symbols refer to the identical components throughout the drawings.

It should be understood that the drawings are simplified to illustrate various features in the principles of the present disclosure and are not necessarily drawn to scale. A specific design feature disclosed in the present disclosure (e.g., including specific size, orientation, location, and shape) is partially determined by the specific intended application and usage environment.

In the drawings, the same reference numerals represent the same or equivalent parts of the present disclosure throughout the several accompanying drawings.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, each embodiment of the present disclosure is described in detail. These embodiments are illustrated in the accompanying drawings, and presented as follows. Although the present disclosure is described with reference to specific embodiments, it should be understood that this specification is not intended to limit the present disclosure to these specific embodiments. On the other hand, the present disclosure may include not only these specific embodiments, but also various alternative forms, modified forms, equivalent forms, and other embodiments that may be included within a scope defined by the spirit of the present disclosure and the appended claims.

A locking mechanism for a seat extension according to an embodiment of the present disclosure is intended to detachably mount the seat extension onto a seat backrest. The seat extension may be firmly fixed to the seat backrest in a stored state of the seat extension, and the seat extension may be unlocked from the seat backrest and unfolded in an unlocked state of the seat extension.

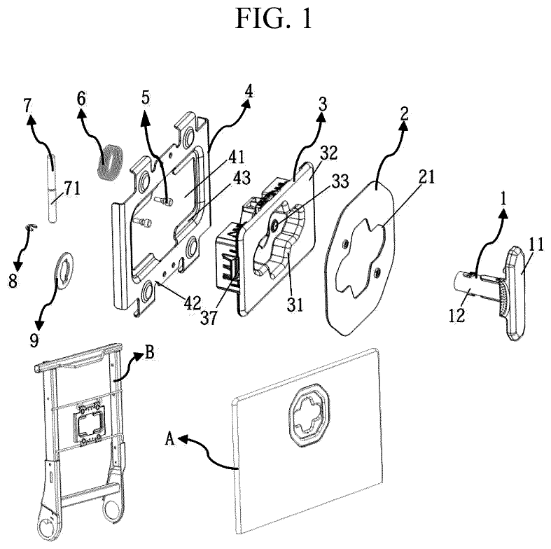

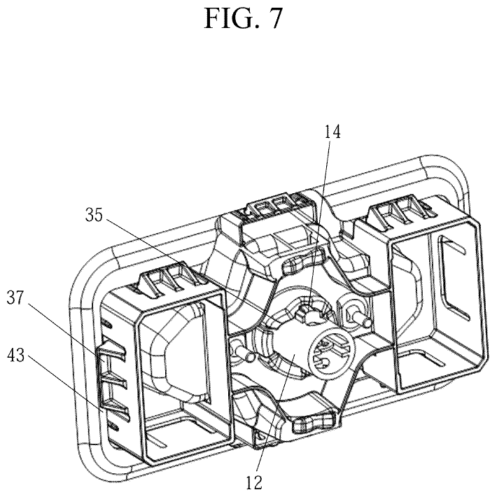

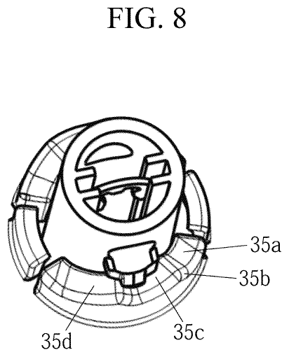

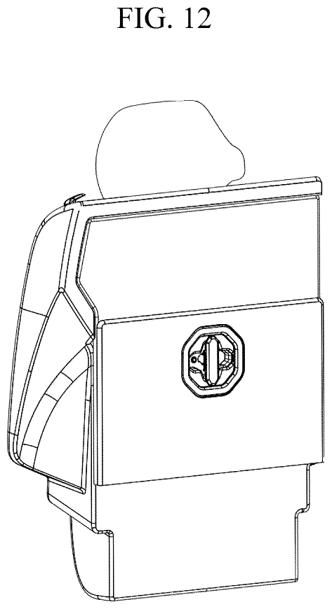

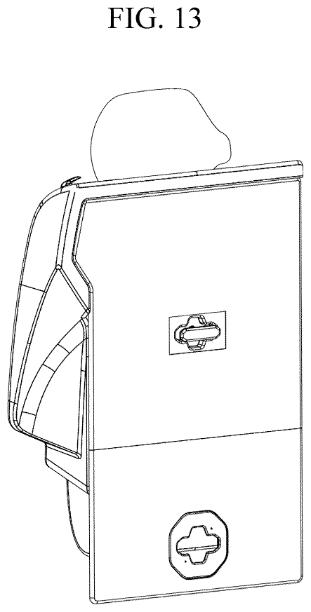

Hereinafter, the description describes the locking mechanism for the seat extension according to an embodiment of the present disclosure in detail with reference to FIGS. 1 through 13.

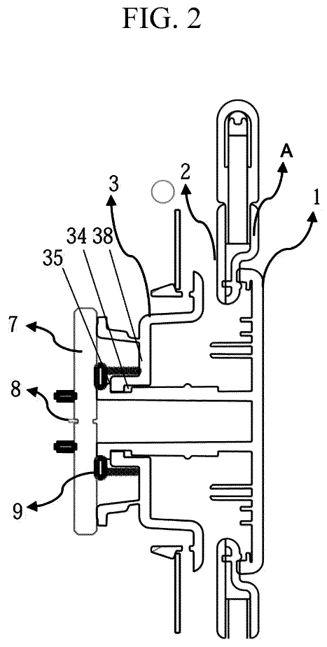

Referring to FIGS. 1 and 2, the locking mechanism for the seat extension A according to an embodiment of the present disclosure may include a locking lever 1, an engagement plate 2, a housing 3, a bracket 4, a spring 6, and a pin shaft 7.

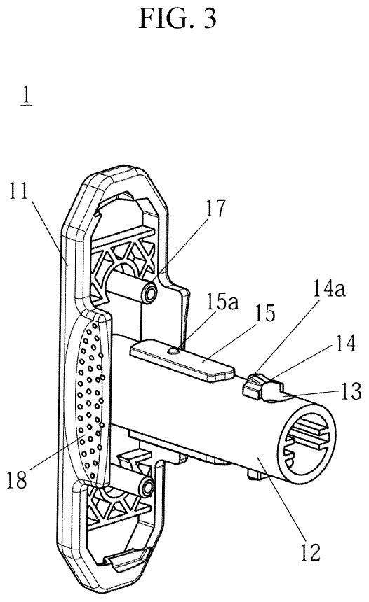

FIG. 3 is a schematic perspective view of the locking lever included in the locking mechanism for the seat extension according to an embodiment of the present disclosure. Referring to FIG. 3, the locking lever 1 may have an overall T-shaped structure and include a handle 11 and a lever 12 perpendicular to the handle 11.

A user may turn the locking lever 1 by gripping the handle 11 during manipulation. In addition, the handle 11 is intended to press the seat extension to the seat backrest in the stored state. Two externally protruding buffer columns 17 may be disposed on a bottom surface of the handle 11, and the buffer column 17 may be coupled to a buffer component 5 disposed in the housing 3 to thus reduce an impact force between the lever 12 and the housing 3. In this embodiment, two buffer columns 17 and two buffer components 5 may be provided, respectively.

A gripping portion 18 may be disposed on each of two sides of the handle 11, and granular protrusions may be disposed on the gripping portion 18 to increase a frictional force.

The lever 12 may have one pinhole 13 in one end far from the handle 11.

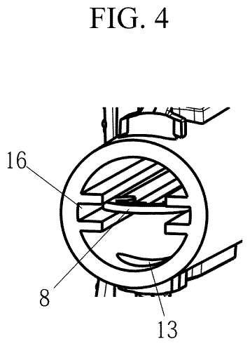

In an example, a hole extending along an axis may be disposed in an end portion of the lever 12, and an insertion groove 16 may be disposed in each of two sides of the hole for mounting a circlip 8 therein (see FIG. 4).

Referring to FIG. 1, the engagement plate 2 may have a plate-like structure and may be fixedly mounted on the seat extension A. For example, the engagement plate 2 may be connected to the seat extension A through a pin, thereby allowing the seat extension A to have a good appearance after unfolding.

A plate hole 21 may be disposed in the center of the engagement plate 2. In this embodiment, the plate hole 21 may be a cross-shaped opening. An opening length of the cross-shaped opening in one direction (i.e., a first direction) may be greater than or equal to a length of the handle 11 of the locking lever 1, and the locking lever 1 may thus pass through the opening in the first direction; and an opening length of the cross-shaped opening in another direction (i.e., a second direction) may be less than the length of the handle 11 of the locking lever 1, and the handle 11 of the locking lever 1 may thus be engaged with the opening in the corresponding direction. In this embodiment, the cross-shaped opening may have an opening length in a horizontal direction that is greater than the length of the handle 11 of the locking lever 1, and the cross-shaped opening may have an opening length in a vertical direction that is less than the length of the handle 11 of the locking lever 1. That is, the first direction refers to the horizontal direction and the second direction refers to the vertical direction. When the handle 11 of the locking lever 1 is turned in the first direction, the handle 11 may pass through the opening of the engagement plate 2 in the first direction, and the engagement plate 2 may thus be unfolded without restriction. When the handle 11 of the locking lever 1 is turned in the second direction, the handle 11 may be firmly engaged with an edge of the opening in the engagement plate 2 in the second direction.

If the opening in the engagement plate 2 is set as a cross shape, a manipulator's finger may enter deeply into a recess 31 in the housing 3, thereby making manipulation easier. Selectively, the opening in the engagement plate 2 may have another shape, such as an oval, rectangular, or oblong shape.

A mounting hole 41 and a frame 42 may be disposed in the middle of the bracket 4, and the frame 42 may surround the mounting hole 41 to be used for fixedly mounting the bracket 4 on a frame of the seat backrest B. For example, the frame 42 of the bracket 4 may be fixed to a metal wire of the frame of the seat backrest B by welding.

The housing 3 may be mounted on the bracket 4, and thus be connected to the seat backrest B through the bracket 4, together with the bracket 4. The housing 3 may include an accommodation portion and a mounting portion 32. The accommodation portion may have a box shape, one surface thereof being open, have the recess 31 disposed therein, and pass through the mounting hole 41 in the bracket 4. The mounting portion 32 may be a flange facing outward from the accommodation portion, and the flange may be engaged with the frame 42 of the mounting hole 41 in the bracket 4.

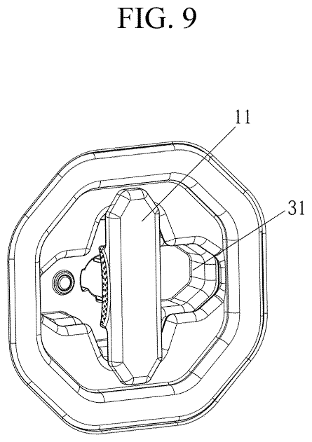

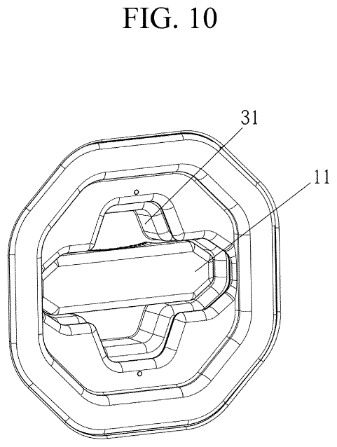

A shape of the recess 31 may correspond to a shape of the opening in the engagement plate 2. That is, a length of the recess 31 in one direction (i.e., the first direction) may be greater than or equal to the length of the handle 11 of the locking lever 1, and the handle 11 of the locking lever 1 may thus be accommodated in the recess 31 in the corresponding direction (see FIG. 10); and a length of the recess 31 in another direction (i.e., the second direction) may be less than the length of the handle 11 of the locking lever 1 (see FIG. 9). In this embodiment, an opening length of the recess 31 in the horizontal direction may be greater than the length of the handle 11 of the locking lever 1, and an opening length of the recess 31 in the vertical direction is less than the length of the handle 11 of the locking lever 1. That is, the first direction refers to the horizontal direction, and the second direction refers to the vertical direction. The recess 31 is provided for accommodating the locking lever 1, and when the locking lever 1 is turned and unlocked, the handle 11 of the locking lever 1 may enter the recess 31 by a force of the spring 6.

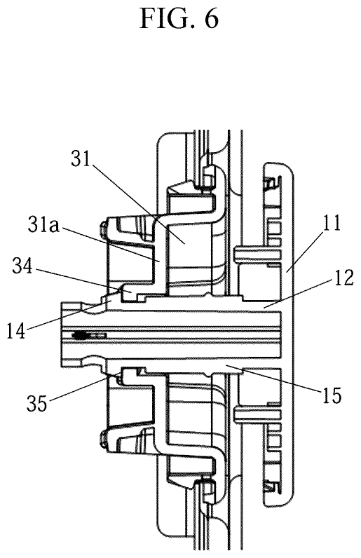

Referring to FIGS. 2 and 6, the lever 12 may protrude from a bottom surface of the recess 31 by passing through the plate hole 21 in the engagement plate 2 and the recess 31 in the housing 3.

Referring to FIG. 1, two buffer component holes 33 for mounting the buffer components 5 may be disposed in the bottom surface of the recess 31.

A plurality of engagement grooves 37 may be disposed in an outer side of the housing 3, an engagement element 43 may be disposed on the bracket 4, and the engagement element 43 of the bracket 4 may be engaged with the engagement groove 37 of the housing 3 to thus connect the housing 3 and the bracket 4 to each other. The engagement groove 37 and the engagement element 43 may be compatible. That is, the engagement groove may be disposed in the bracket 4, and the engagement element may be disposed in the housing 3. Selectively, the housing 3 and the bracket 4 may be formed integrally with each other.

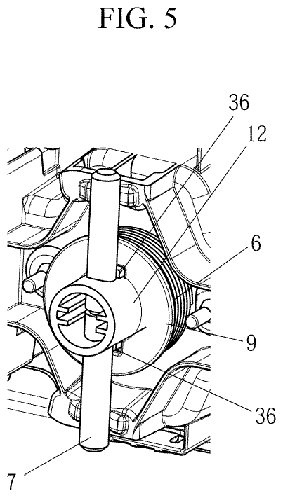

Referring to FIG. 5, the pin shaft 7 may be inserted into the pinhole 13 in the lever 12 of the locking lever 1, thereby restricting an axial movement of the locking lever 1, thus allowing the locking lever 1 to be mounted in the housing 3.

Referring to FIGS. 4 and 5, a circlip groove 71 may be disposed in a middle portion of the pin shaft 7. The circlip 8 may be engaged with the circlip groove 71 of the pin shaft 7 to thus connect the pin shaft 7 to the lever 12 of the locking lever 1. The circlip 8 may be inserted into the insertion groove 16 of the lever 12 of the locking lever 1, and the insertion groove 16 may restrict a movement of the circlip 8 in an axial direction of the pin shaft 7, thereby preventing a movement of the pin shaft 7 in the axial direction.

Referring to FIGS. 2 and 5, the spring 6 may be disposed on an outer side of the recess 31 and between the pin shaft 7 and a bottom plate 38 of the recess 31 in the housing 3. The spring 6 may apply an elastic force to the locking lever 1, thereby allowing the locking lever 1 to be pressed against the engagement plate 2 or the housing 3.

In an example, the locking mechanism according to an embodiment of the present disclosure may further include a washer 9. The washer 9 may be disposed between the spring 6 and the pin shaft 7 to thus provide a larger contact surface for coupling these two components, thereby enabling the force of the spring 6 to be more effectively applied to the pin shaft 7.

Referring to FIG. 1, the buffer component 5 may be disposed within the bottom plate 38 of the recess 31 in the housing 3, and coupled to the buffer column 17 of the locking lever 1, thereby buffering a recoil impact of the locking lever 1. In this embodiment, two buffer components 5 may be provided, and respectively correspond to two buffer columns 17 disposed on left and right sides of the handle 11 of the locking lever 1.

Referring to FIG. 3, in order to more effectively manipulate the locking lever 1, the locking mechanism for the seat extension according to an embodiment of the present disclosure may further include a guide block 14 disposed on the lever 12. The guide block 14 may be disposed adjacent to the pinhole 13 and disposed on an inner side of the pinhole 13 (i.e., on one side of the lever 12 that is closer to the handle 11), and the guide block 14 may protrude radially outward from an outer peripheral surface of the pin shaft 7. An inner side of the guide block 14 may be formed as an arcuate surface 14a for coupling with a guide surface 35 of the housing 3. In this embodiment, two guide blocks 14 may be provided and disposed in opposite directions along a radial direction of the lever 12.

The guide block 14 may be always pressed against the guide surface 35 of the recess 31 by the force of the spring 6. When the user turns the locking lever 1, the locking lever 1 may move in the axial direction by moving the guide block 14 on the guide surface 35.

A joining block 15 may further be disposed on the lever 12. The joining block 15 may be disposed on the inner side of the guide block 14 (i.e., one side of the lever 12 that is close to the handle 11), and the joining block 15 may be provided for coupling with a guide hole 34 of the housing 3. A height of the joining block 15 may be approximately the same as a height of the guide block 14. In this embodiment, two joining blocks 15 may be provided, and disposed in the opposite directions along the radial direction of the lever 12. In an example, a protrusion point 15a may be disposed on a surface of the joining block 15 to increase a frictional force of the joining block 15 with the guide hole 34 of the housing 3.

Referring to FIGS. 2 and 6, the guide hole 34 may be disposed in a bottom surface 31a of the recess 31, and the lever 12 of the locking lever 1 may pass through the inside of the guide hole 34. The guide hole 34 may protrude outwardly from the bottom plate 38 of the recess 31, and the inside of the guide hole 34 may be formed in a stair-like shape. Notches 36 respectively corresponding to the guide block 14 and the joining block 15 of the lever 12 may be disposed on a side of the guide hole 34. The locking lever 1 may be mounted in the housing 3 by the lever 12 passing through the notch 36.

The guide surface 35 may be disposed on an outer surface of the guide hole 34 and in contact with the arcuate surface 14a of the guide block 14, thereby guiding the locking lever 1 to move in the axial direction. The guide surface 35 may be formed in a stair-like shape, and include a first section 35a, a transition section 35b, a second section 35c, and a stopper section 35d. Here, distances between neighboring two of the first section 35a, the second section 35c, the stopper section 35d, and the bottom surface 31a may respectively increase sequentially. When the guide block 14 of the locking lever 1 and the first section 35a are in contact with each other, the locking lever 1 may be in the stored state (i.e., the handle 11 of the locking lever 1 may be located in the recess 31 in the housing 3, as shown in FIG. 10). When the guide block 14 of the locking lever 1 and the second section 35c are in contact with each other, the locking lever 1 may be in the engaged state (i.e., the handle 11 of the locking lever 1 is engaged with an edge of the cross hole in the engagement plate 2, as shown in FIG. 9). The transition section 35b refers to an inclined portion that allows the guide block 14 to move smoothly from the first section 35a to the second section 35c. The stopper section 35d is intended to prevent further rotation of the locking lever 1.

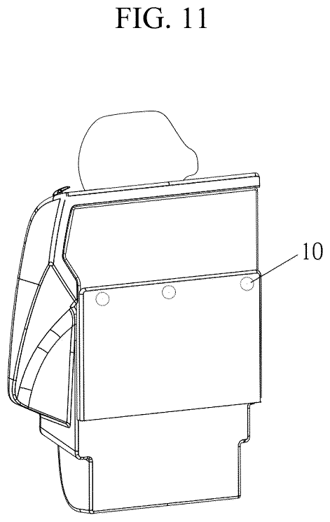

FIG. 11 is a schematic view of a modified example of the locking mechanism for the seat extension according to an embodiment of the present disclosure, where the seat extension A may be attached to the seat backrest B by using a magnet 10.

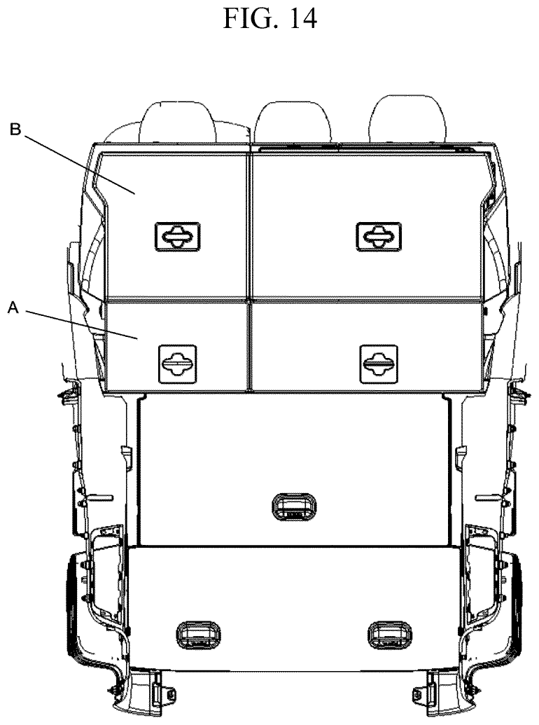

FIG. 14 is a schematic view of the seat extension in an unfolded state in the locking mechanism for the seat extension according to another embodiment of the present disclosure, where two locking mechanisms are provided.

Hereinafter, the description describes a process of using the locking mechanism for the seat extension according to an embodiment of the present disclosure.

When the seat extension A is to be used, the seat extension A is required to be switched from the stored state to the unfolded state. In the stored state of the seat extension A, the handle 11 of the locking lever 1 may have a vertical position, and the handle 11 may be pressed against the plate hole 21 in the engagement plate 2.

When the user turns the handle 11 of the locking lever 1 by 90 degrees from the vertical position to a horizontal position, the handle 11 may be aligned with the opening in the plate hole 21 in the engagement plate 2 and the recess 31 in the housing 3 in the first direction and pass through the plate hole 21 to thus enter the recess 31 in the housing 3. When the user releases the handle 11 of the locking lever 1, the locking lever 1 may then move in the axial direction of the recess 31 by the force of the spring 6 until the buffer column 17 of the locking lever 1 comes in contact with the buffer component 5 disposed on the bottom surface of the recess 31 in the housing 3. Here, the handle 11 of the locking lever 1 may completely be inserted into the recess 31 in the housing 3 and does not protrude outward. In this state, the seat extension A may be unfolded to enter the unfolded state.

When the seat extension A is to be stored, the seat extension A may be folded and stored. The user may then use the plate hole 21 in the engagement plate 2 and the recess 31 in the housing 3 to grip the handle 11 of the locking lever 1 and pull the locking lever 1 outward (here, the handle 11 of the locking lever 1 is in the horizontal state), thereby causing the locking lever 1 to detach from the recess 31 in the seat extension A and the plate hole 21 in the engagement plate 2. The user may then turn the handle 11 of the locking lever 1 to the vertical state and release the locking lever 1 to thus allow the handle 11 to be pressed against the edge of the plate hole 21 in the engagement plate 2, thereby locking the engagement plate 2 to the seat backrest B. Accordingly, the seat extension A may enter the stored state.

In the locking mechanism for the seat extension according to an embodiment of the present disclosure, when the seat backrest is placed horizontally, the seat extension A may be unfolded to thus form a bed together with the seat backrest and a luggage board, thereby allowing the user to lie down and rest. The locking lever according to an embodiment of the present disclosure may be hidden in the recess in the seat backrest, and does not protrude from the seat backrest when the seat extension is unfolded to form the bed. When the seat is used as a seat and the seat extension is not used, the locking lever may be hidden to eliminate any protrusion from the seat backrest. An embodiment of the present disclosure may improve comfort of a resting space provided using the rear seat. Furthermore, the locking mechanism according to an embodiment of the present disclosure has a simple structure, convenient manipulation, and low cost.

The locking mechanism for the seat extension according to an embodiment of the present disclosure may be used for the vehicle seat, and may also be applied to a seat for other transportation means, such as ships, airplanes, or the like in addition to the vehicles.

Hereinabove, the specific embodiments of the present disclosure are described for the purpose of illustration and description. The description provided above is not intended to be exhaustive or restrictive in the precise form in which the present disclosure is disclosed, and it is clear that various modifications and variations are possible based on the aforementioned description. The specific embodiments are selected and described to illustrate particular principles of the present disclosure and their practical applications, thereby enabling those skilled in the art to implement and utilize various embodiments and other alternative and modified forms of the present disclosure. The scope of the present disclosure may be limited by the appended claims and their equivalent forms.

What is claimed is:

1. A locking mechanism for a seat extension for detachably mounting the seat extension onto a seat backrest of a vehicle, the locking mechanism comprising:
an engagement plate mounted on the seat extension and having an opening disposed in the engagement plate;
a bracket mounted on the seat backrest;
a housing mounted on the bracket and including a recess disposed in the housing;
a locking lever including a handle and a lever, the lever protruding from a bottom surface of the recess by passing through the opening in the engagement plate and the recess in the housing and having a pinhole disposed in an end portion of the lever;
a pin shaft inserted into the pinhole in the end portion of the lever; and
a spring disposed between an outer surface of the recess and the pin shaft.

2. The locking mechanism of claim 1, wherein when the seat extension is to be unfolded, the locking lever is turned and passes through the opening in the engagement plate to be stored in the recess in the housing, thereby allowing the seat extension to be unfolded beyond the locking lever.

3. The locking mechanism of claim 1, wherein when the seat extension is to be stored, the seat extension is folded onto the seat backrest, and the locking lever is pulled and turned, thereby allowing the handle of the locking lever to be engaged with an edge of the opening in the engagement plate.

4. The locking mechanism of claim 1, wherein the opening in the engagement plate is a cross-shaped hole, the cross-shaped hole including an opening in a first direction and an opening in a second direction, an opening length in the first direction being greater than or equal to a length of the handle, and an opening length in the second direction being less than the length of the handle.

5. The locking mechanism of claim 4, wherein the first direction is a horizontal direction, and the second direction is a vertical direction.

6. The locking mechanism of claim 1, wherein the recess in the housing is a cross-shaped recess, the cross-shaped recess including a recess in the first direction and a recess in the second direction, a recess length in the first direction being greater than or equal to the length of the handle, and a recess length in the second direction being less than the length of the handle.

7. The locking mechanism of claim 6, wherein the first direction is a horizontal direction, and the second direction is a vertical direction.

8. The locking mechanism of claim 1, further comprising a buffer component, wherein the buffer component is disposed within the bottom surface of the recess, and a buffer column is disposed on the handle and corresponds to the buffer component.

9. The locking mechanism of claim 1, wherein an engagement element is disposed on one of the bracket and the housing, an engagement groove is disposed in the other of the bracket and the housing, and the housing is mounted on the bracket by coupling the engagement element to the engagement groove.

10. The locking mechanism of claim 1, wherein a circlip groove is disposed in the pin shaft, and the circlip is engaged with the circlip groove.

11. The locking mechanism of claim 10, wherein the circlip groove is disposed in a middle portion of the pin shaft, a hole is disposed in an end portion of the locking lever, an insertion groove is disposed in the hole, and the circlip is engaged with the circlip groove of the pin shaft along the insertion groove.

12. The locking mechanism of claim 1, wherein a guide block is disposed on the end portion of the lever, the guide block is disposed on an inner side of the pin shaft, a guide hole is disposed in the bottom surface of the recess, a guide surface is disposed on an outer surface of the guide hole, and the guide block is joined to the guide surface by a force of the spring.

13. The locking mechanism of claim 12, wherein the guide surface includes a first section, a transition section, a second section, and a stopper section, distances by which the first section, the second section, and the stopper section respectively protrude from the bottom surface of the recess increase sequentially, and the transition section is an inclined portion between the first section and the second section.

14. The locking mechanism of claim 13, wherein a joining block is disposed on the lever and joined to the guide hole, and the joining block is disposed at a position closer to the handle than the guide block of the lever.

15. The locking mechanism of claim 1, further comprising a washer, wherein the washer is disposed between the spring and the pin shaft.

16. The locking mechanism of claim 1, wherein a gripping portion is disposed on a side of the handle, and a protrusion point is disposed on the gripping portion.

17. A rear seat of the vehicle comprising the locking mechanism of claim 1.

18. A vehicle comprising the locking mechanism of claim 1.
